(19) United States
(12) Patent Application Publication
(10) Pub. No.: US 2013/0188790 A1
(43) Pub. Date: Jul. 25, 2013

(54) CRYPTOGRAPHIC KEY

(71) Applicants: Susan K. Langford, Sunnyvale, CA (US); Bryan Gene Olson, Sunnyvale, CA (US)

(72) Inventors: Susan K. Langford, Sunnyvale, CA (US); Bryan Gene Olson, Sunnyvale, CA (US)

(21) Appl. No.: 13/357,217

(22) Filed: Jan. 24, 2012

(51) Int. Cl. H04L 9/06

(52) U.S. Cl. 380/44

(57) ABSTRACT

A technique to facilitate cryptographic key management is provided. In one aspect, multiple strings or components are sorted and concatenated in the order in which they were sorted.

### BACKGROUND

Key management provides the foundation for the secure generation, storage, distribution, and translation of cryptographic keys. Key management may include the practice of split knowledge and dual control. Split knowledge is a condition under which each individual has only partial knowledge of an entire secret. In cryptology, split knowledge may be implemented by two or more parties such that each party has a key component which, individually, conveys no knowledge of the resultant cryptographic key. A key component may be a string of characters. The resultant key may exist only within a secure computer apparatus, which may perform bitwise operations (e.g., exclusive or “XOR”) on said key components to generate the final key. Dual control is a process of utilizing two or more separate entities (usually administrators), operating in concert, to authorize sensitive functions or to access information. It is the policy of many institutions, such as retail banks, to require manual entry of the initial components or strings into a computer with suitable key generation software therein.

Cryptographic keys and the components thereof were once 56 bits in length. The advent of increasing processor speeds made 56 bit keys vulnerable to “brute force” attacks, which involve a systematic attempt of every possible key until the correct key is found. Processors are now capable of attempting every 56 bit key permutation in less than one day. The resources required for a brute force attack grow exponentially with increasing key size. Accordingly, cryptographic keys and their associated components are now 128 to 256 bits in length. An attempt of every possible 256 bit key is unfeasible due to the vast number of permutations.

### BRIEF DESCRIPTION OF THE DRAWINGS

FIG. 1 is an example of a computer apparatus in accordance with aspects of the disclosure.

FIG. 2 is an illustrative flow diagram of a method for cryptographic key generation in accordance with aspects of the disclosure.

FIG. 3 is a working example of cryptographic key generation in accordance with aspects of the disclosure.

FIG. 4 is a further working example of cryptographic key generation in accordance with aspects of the disclosure.

### DETAILED DESCRIPTION

As noted above, the dual control policy of many institutions require manual entry of the initial components or strings into a computer. However, the shift toward 128-256 bit keys makes manual entry of such strings cumbersome, time consuming, and prone to errors. Generating a key from an XOR of two components requires each component to have the same length as the final key. Requiring the components to have the same length as a 128-256 bit key is inconvenient and may require expensive upgrades to existing systems and procedures. Administrators are expected to enter these long strings of characters correctly into a keyboard. Furthermore, the initial components may be leaked by unscrupulous administrators conspiring with third parties to reverse engineer the key from the initial strings.

In view of the foregoing concerns, various examples disclosed herein provide an apparatus and method that facilitates manual key management while enhancing the security thereof. In one aspect, multiple strings may be accessed. Each string may have a bit length shorter than that of a cryptographic key. This allows each administrator to enter a shorter string or component. In a further aspect, the multiple strings may be sorted in an order and concatenated in the order in which they were sorted to generate the cryptographic key. This allows users to reproduce the key from the components without recording the order in which they were entered. The key may be reproduced by entering the components in any order. The security is only limited by the bit-size of the final derived key. If any component is obtained by an attacker, the security of the unexposed components may still be preserved. The aspects, features and advantages of the application will be further appreciated when considered with reference to the following description of examples and accompanying figures. The following description does not limit the application; rather, the scope of the application is defined by the appended claims and equivalents.

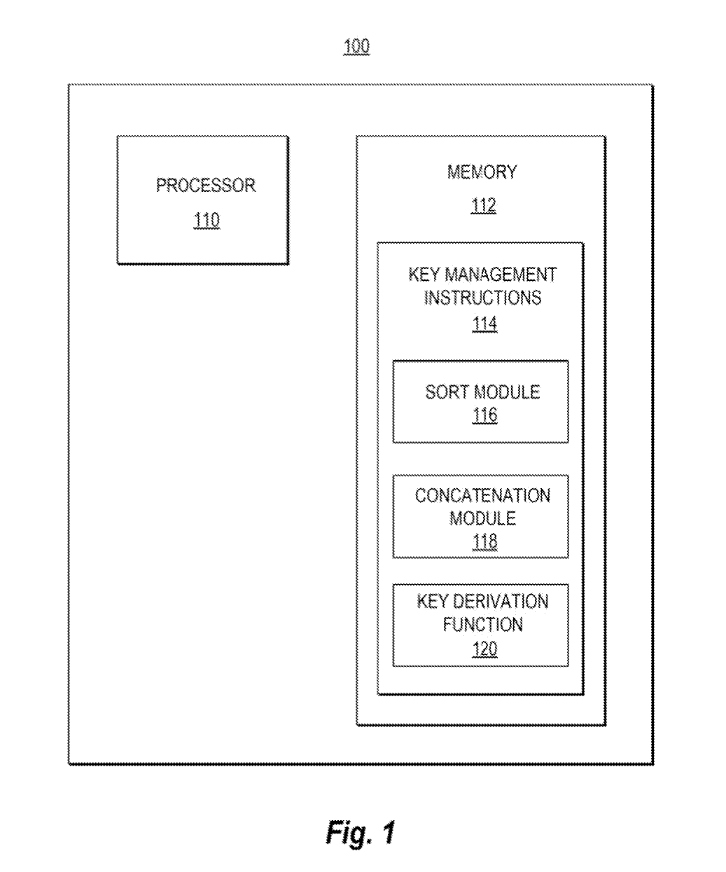

FIG. 1 presents a schematic diagram of an illustrative computer apparatus 100 depicting various components in accordance with aspects of the disclosure. The computer apparatus 100 may include all the components normally used in connection with a computer. For example, it may have a keyboard and mouse and/or various other types of input devices such as pen-inputs, joysticks, buttons, touch screens, etc., as well as a display, which could include, for instance, a CRT, LCD, plasma screen monitor, TV, projector, etc. Computer apparatus 100 may also comprise a network interface (not shown) to communicate with other devices over a network using conventional protocols (e.g., Ethernet, Wi-Fi, Bluetooth, etc.).

The computer apparatus 100 may also contain a processor 110 and memory 112. Memory 112 may store key management instructions 114 that may be retrieved and executed by processor 110. In one example, memory 112 may be a random access memory (“RAM”) device. In a further example, memory 112 may be divided into multiple memory segments organized as dual in-line memory modules (DIMMs). Alternatively, memory 112 may comprise other types of devices, such as memory provided on floppy disk drives, tapes, and hard disk drives, or other storage devices that may be coupled to computer apparatus 100 directly or indirectly. The memory may also include any combination of one or more of the foregoing and/or other devices as well. The processor 110 may be any number of well known processors, such as processors from Intel® Corporation. In another example, the processor may be a dedicated controller for executing operations, such as an application specific integrated circuit (“ASIC”). Although all the components of computer apparatus 100 are functionally illustrated in FIG. 1 as being within the same block, it will be understood that the components may or may not be stored within the same physical housing. Furthermore, computer apparatus 100 may actually comprise multiple processors and memories working in tandem.

The key generation techniques disclosed herein may be implemented in key management instructions 114 residing in memory 112. Key management instructions 114 may comprise any set of machine readable instructions to be executed directly (such as machine code) or indirectly (such as scripts) by the processor(s). In that regard, the terms “instructions,” “modules” and “programs” may be used interchangeably herein. The instructions may be stored in any computer language or format, such as in object code or modules of source code. Furthermore, it is understood that the instructions may be implemented in the form of hardware, software, or a combination of hardware and software and that the examples herein are merely illustrative. Illustrative functions, methods and routines of key management instructions 114 (e.g., sort module 116, concatenation module 118, and key derivation function 120) are explained in more detail below.

In one example, key management instructions 114 may be realized in any non-transitory computer-readable media for use by or in connection with an instruction execution system such as computer apparatus 100, an ASIC, or other system that can fetch or obtain the logic from non-transitory computer-readable media and execute the instructions contained therein. “Non-transitory computer-readable media” can be any media that can contain, store, or maintain programs and data for use by or in connection with the instruction execution system. Non-transitory computer readable media may comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, or a portable compact disc.

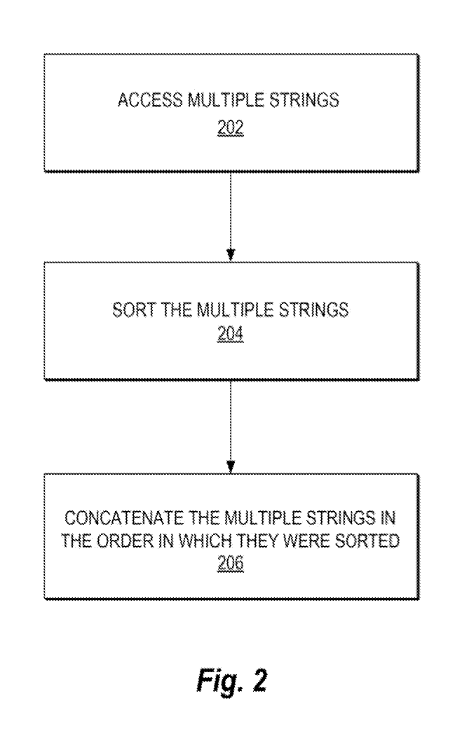

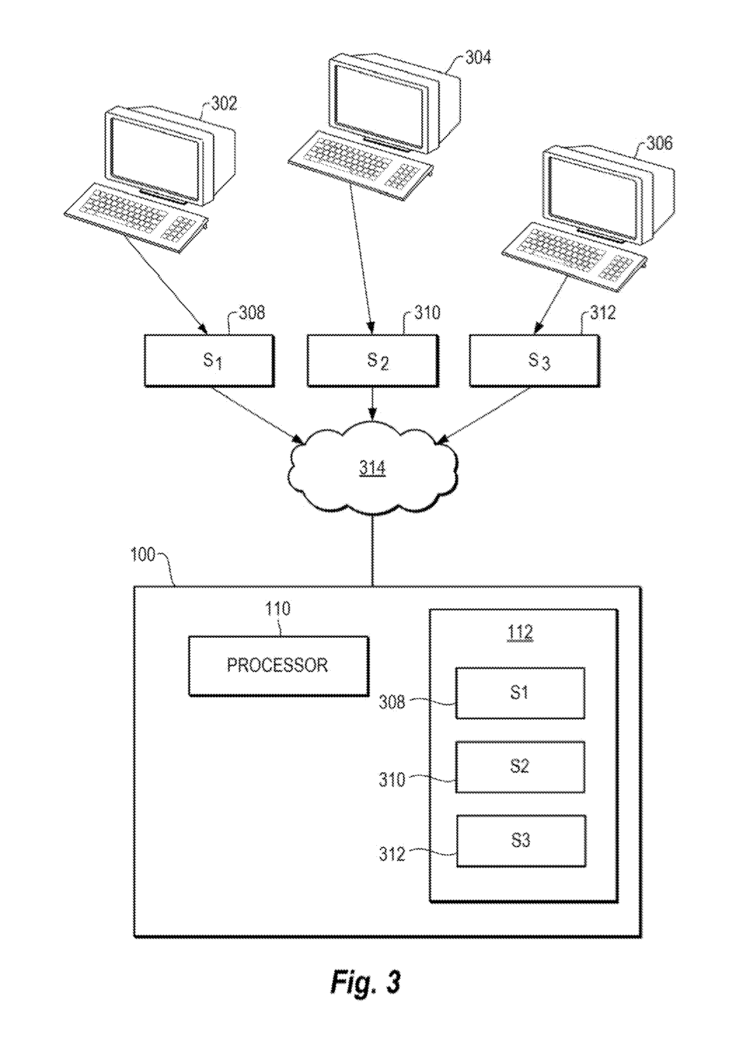

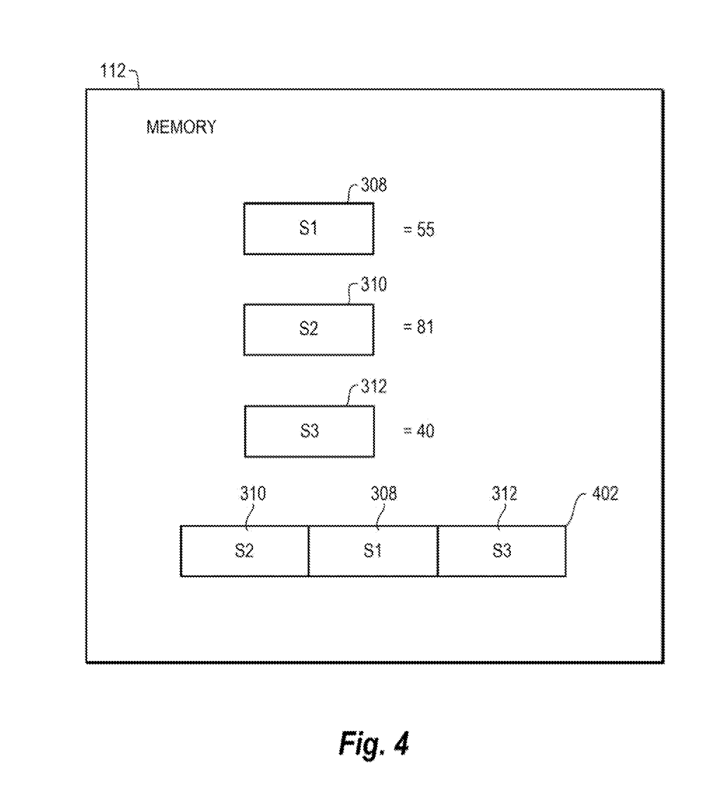

One working example of the apparatus and method is shown in FIGS. 2-4. In particular, FIG. 2 shows a flow diagram of an illustrative process for cryptographic key management. FIGS. 3-4 show aspects of cryptographic key generation. The actions shown in FIGS. 3-4 will be discussed below with regard to the flow diagram of FIG. 2.

As shown in block 202 of FIG. 2, multiple components may be accessed or read. Each component may be a string of characters. The strings may have been manually entered into remote computers by administrators and may be received therefrom via a network. Each component or string may represent a portion of a cryptographic key such that each string has a bit length shorter than that of the cryptographic key. Referring now to FIG. 3, client computers 302, 304, and 306 are shown transmitting three strings S1, S2, and S3, which are labeled 308, 310, and 312 respectively. The three strings may be transmitted over network 314 to computer apparatus 100 and may be stored in memory 112. While only three strings are illustrated in this example, the number of strings may correspond to the level of risk an entity can afford. The higher the number of strings the harder it may be to reverse engineer the cryptographic key, however, more administrators may be required for manual entry thereof. In one example, the number of strings is at least three. Instead of requiring administrators to type strings that are equal in length to the final cryptographic key, shorter strings may be entered when the key is divided into three or more components. The bit length of the cryptographic key may equal the sum of the bit lengths of the multiple strings or components. However, the bit length of each individual string may vary.

As noted above, the strings may be transmitted to computer apparatus 100 over network 314. Network 314 may be a local area network (“LAN”), wide area network (“WAN”), the Internet, etc. Network 314 and intervening nodes may also use various protocols including virtual private networks, local Ethernet networks, private networks using communication protocols proprietary to one or more companies, cellular and wireless networks, HTTP, and various combinations of the foregoing. Although only a few computers are depicted in FIG. 3, it should be appreciated that a network may include additional interconnected computers.

Referring back to FIG. 2, the multiple strings may be sorted, as shown in block 204. Sort module 116 of FIG. 1 may sort the multiple strings in a variety of ways. In one example, the sort order may be determined instantaneously or in real-time upon access to the strings or when the strings are read. Each string may be passed through a secret hash function and assigned a hash value. The hash function may be a component of sort module 116. The multiple strings may then be sorted by their respective hash values. Referring back to FIG. 2, the multiple strings may be concatenated or joined in the order in which they were sorted, as shown in block 206. Such concatenation may be carried out by concatenation module 118. Sort module 116 may pass the sort order to concatenation module 118.

Referring now to FIG. 4, a hash value may be calculated from strings 308, 310, and 312. The hash values derived from the strings may be hash values 55, 81, and 40 respectively. FIG. 4 shows strings 308, 310, and 312 concatenated to produce a cryptographic key 402. In the example of FIG. 4, the order, from right to left, of the strings included in cryptographic key 402 is string 310, string 308, and string 312, in accordance with the descending order of their respective hash values (i.e., 81, 55, and 40). In another example, the order may be reversed such that the concatenation is carried out from left to right or the order may be in ascending order. In one example, the sort order may be transiently stored such that sort module 116 disregards the sort order. For example, the sort order may be disregarded once concatenation of the strings is complete. The derived hash values associated with each string may also be used to detect manual entry errors. For example, a manual entry error may be raised if two or more hash values are equal to each other such that the strings associated therewith are rejected. The detection of identical hash values derived from two or more separate strings may be indicative of a manual entry error.

The string generated by concatenation module 118 may be deemed the final cryptographic key (e.g., cryptographic key 402). However, in a further example, cryptographic key 402 may be forwarded to an additional module to further enhance the security thereof. Key derivation function (“KDF”) 120, shown in FIG. 1, may comprise any function enabled to manipulate a series of bits so as to generate an alternate cryptographic key. The output of concatenation module 118 may be the input to KDF 120. KDF 120 may perform any variety of operations upon the received input to generate an alternate cryptographic key different than cryptographic key 402. In one example, KDF 120 may be consistent with the standards disclosed in the National Institute of Standards and Technology (“NIST”) special publication 800-108. The output of KDF 120 may be deemed the final cryptographic key. The final cryptographic key may be used as a symmetric key or may be one key of an asymmetric key system.

Advantageously, the above-described apparatus and method facilitates maintenance of cryptographic keys while protecting against brute force attacks and potential leaks by unscrupulous administrators. In this regard, entity managers can be certain that the system is secure from reverse engineering. Furthermore, the burden placed on administrators, who enter components manually, may be alleviated, while the security benefits of a longer key are preserved.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the application as defined by the appended claims. Furthermore, while particular processes are shown in a specific order in the appended drawings, such processes are not limited to any particular order unless such order is expressly set forth herein. Rather, processes may be performed in a different order or concurrently, and steps may be added or omitted.

1. An apparatus comprising:
a processor;
instructions which, if executed, cause the processor to:
access multiple strings, each string representing a portion of a cryptographic key such that each string has a bit length shorter than that of the cryptographic key;
sort the multiple strings in an order; and
concatenate the multiple strings in the order in which they were sorted to generate the cryptographic key.

2. The apparatus of claim 1, wherein the order in which the multiple strings are sorted is determined upon access to the multiple strings.

3. The apparatus of claim 2, wherein the instructions, if executed, further cause the processor to:
assign a hash value to each string of the multiple strings such that the sort order is based on the hash value of each string.

4. The apparatus of claim 1, wherein the instructions, if executed, further cause the processor to:
forward the cryptographic key to a key derivation function; and
generate a final cryptographic key based on the forwarded cryptographic key using the key derivation function.

5. The apparatus of claim 1, wherein the multiple strings are at least three strings.

6. The apparatus of claim 1, wherein a bit length of the cryptographic key equals a sum of bit lengths of the multiple strings.

7. The apparatus of claim 1, wherein the order in which the multiple strings are sorted is transiently stored.

8. A non-transitory computer readable medium having instructions stored therein which if executed cause a processor to:
read multiple components of a cryptographic key, each component having a bit length shorter than that of the cryptographic key;
sort the multiple components in an order; and
concatenate the multiple components in the order in which they were sorted to generate the cryptographic key.

9. The computer readable medium of claim 8, wherein the order in which the multiple components are sorted is determined when the multiple components are read.

10. The computer readable medium of claim 9, having instructions stored therein which if executed further cause the processor to:
assign a hash value to each component of the multiple components such that the sort order is based on the hash value of each string.

11. The computer readable medium of claim 8, having instructions stored therein which if executed further cause the processor to:
forward the cryptographic key to a key derivation function; and
generate a final cryptographic key based on the forwarded cryptographic key using the key derivation function.

12. The computer readable medium of claim 8, wherein the multiple components are at least three components.

13. The computer readable medium of claim 8, wherein a bit length of the cryptographic key equals a sum of bit lengths of the multiple components.

14. The computer readable medium of claim 8, wherein the order in which the multiple components are sorted is transiently stored.

15. A method comprising:
accessing multiple strings, each string having a bit length shorter than that of a cryptographic key;
sorting the multiple strings in an order; and
concatenating the multiple strings in the order in which they were sorted to generate the cryptographic key.

16. The method of claim 15, wherein the order in which the multiple strings are sorted is determined when the multiple strings are accessed.

17. The method of claim 16, further comprising
assigning a hash value to each string of the multiple strings such that the sort order is based on the hash value of each string.

18. The method of claim 15, further comprising
forwarding the cryptographic key to a key derivation function; and
generating a final cryptographic key based on the forwarded cryptographic key using the key derivation function.

19. The method of claim 15, wherein the multiple strings are at least three strings.

20. The method of claim 15, wherein a bit length of the cryptographic key equals a sum of bit lengths of the multiple strings.
